(19) United States
(12) Patent Application Publication
(10) Pub. No.: US 2025/0162886 A1
(43) Pub. Date: May 22, 2025

(54) METHOD FOR REMOVING IMPURITIES FROM QUARTZ INCLUSIONS BY HYDROTHERMAL DENUDATION COMBINED WITH ACID LEACHING

(71) Applicant: Northeastern University, Shenyang (CN)

(72) Inventors: Wengang LIU, Shenyang (CN); Ruirui ZHANG, Shenyang (CN); Wenbao LIU, Shenyang (CN); Weichao LI, Shenyang (CN); Qing JIA, Shenyang (CN)

(21) Appl. No.: 19/027,811

(22) Filed: Jan. 17, 2025

(30) Foreign Application Priority Data
Oct. 22, 2024 (CN) 202411471073.9

(51) Int. Cl. C01B 33/18

(52) U.S. Cl. CPC C01B 33/18; C01P 2006/80

(57) ABSTRACT

The present invention belongs to the technical field of high-purity quartz processing and discloses a method for removing impurities from quartz inclusions by hydrothermal denudation combined with acid leaching. Gas-liquid inclusions on the surface of quartz sand are destroyed by hydrothermal reaction of quartz sand and calcium oxide, and xonotlite produced by the reaction is removed with dilute nitric acid and sodium carbonate solution; and then impurities dissolved in acid and excess acid solution are removed by acid leaching, cleaning and filtering to obtain pure quartz sand. The technology destroys the gas-liquid inclusions by the hydrothermal method and avoids the use of hydrofluoric acid in the acid leaching process, which can effectively reduce the environmental pollution caused by the acid leaching process, exhibiting excellent industrial application potential.

### TECHNICAL FIELD

The present invention relates to the technical field of high-purity quartz processing, and particularly relates to a method for removing impurities in quartz inclusions by hydrothermal denudation combined with acid leaching.

### BACKGROUND

High-purity quartz sand, as an important strategic resource, is mainly used in emerging industries such as photovoltaic power, semiconductor, aviation and military industry. High-end industries have high requirements for the purity of quartz sand, and the purity of quartz sand used in the production of quartz crucibles is required to be higher than 99.995%.

The preparation of high-purity quartz sand has strict requirements for quartz raw ore, and China is short of high-quality ore resources that can be used to prepare high-purity quartz at 4N5 level and above at present, so deep purification of ores such as vein quartz is particularly important for the development of the high-purity quartz industry in China. However, some impurities in quartz exist in the form of gas-liquid inclusions, which are difficult to be removed by conventional flotation and acid leaching processes and are the main factors affecting the purity of quartz. Therefore, destroying gas-liquid inclusions by physical or chemical means to remove impurities is the key to deep purification of quartz.

CN118047389A destroys gas-liquid inclusions by means of calcining and water quenching, and then performs leaching with mixed acid with a mass ratio of HCl to HF acid to sulfuric acid of 3:1:1 and a mass concentration of 10%-20%.

CN117923499A removes impurities from gas-liquid inclusions in quartz sand by means of microwave acid leaching after calcining and water quenching. Although calcining and water quenching can make use of the difference of physical properties of quartz and gas-liquid inclusions to promote cracks in the inclusions through the principle of thermal expansion and contraction, this process can only destroy a small number of gas-liquid inclusions, it is necessary to add a certain amount of HF acid to help destroy the inclusions in the acid leaching process, and waste liquid containing HF acid is easy to cause environmental pollution.

CN118047388A adopts a pickling-calcining and water quenching-acid leaching process to purify quartz sand, and prevents free impurities in quartz sand from entering gas-liquid inclusions in the calcining process by means of pre-pickling, which affects the acid leaching effect.

The above three processes have prepared quartz sand with purity above 4N, but still rely on HF acid in the acid leaching process, which is not in line with China's industrial development policies and local industry access conditions, greatly limiting industrial applications.

At present, China emphasizes, in the industrial development, the concept of green mine development that we want invaluable assets as well as lucid waters and lush mountains. Therefore, to realize industrial application, high-purity quartz preparation technologies are required to have the characteristics of high process stability, environmental friendliness and simple operation, and take into account green and sustainable development while achieving deep purification of quartz sand.

### SUMMARY

To solve the bottleneck problems in the prior art, the present invention aims to provide a method for removing impurities from quartz inclusions by hydrothermal denudation combined with acid leaching in view of the technical defects existing in the removal of impurities from gas-liquid inclusions in quartz sand at present to destroy gas-liquid inclusions by selecting pollution-free CaO, which is conducive to the industrial production of high-purity quartz sand. The method has the characteristics of simple process, low energy consumption and no pollution, and can be applied to large-scale industrial production.

To achieve the above purpose, the present invention provides a method for removing impurities from quartz inclusions by hydrothermal denudation combined with acid leaching, which destroys gas-liquid inclusions based on hydrothermal synthesis to deeply purify quartz sand. Gas-liquid inclusions on the surface of quartz sand are destroyed by hydrothermal reaction of quartz and CaO, and xonotlite produced by the reaction is removed with dilute HNO₃ and Na₂CO₃ solution; and then impurities dissolved in acid and excess acid solution are removed by acid leaching, cleaning and filtering to obtain pure quartz sand. The method specifically comprises the following steps:

A method for deep purification of quartz sand comprises the following steps:
Step 1: adding ultrapure water to uniformly mix quartz sand and CaO with a mass ratio of 10:1 to obtain a slurry with a liquid-solid ratio of 5:1, pouring the slurry into a hydrothermal reactor, and heating at a constant temperature;
Step 2: removing the slurry from the hydrothermal reactor, pouring the slurry into HNO₃ solution with the same volume as the slurry in step 1, and conducting heating, stirring and filtering;
Step 3: pouring filter residues obtained in step 2 into sodium carbonate solution with the same volume as the HNO₃ in step 2, and conducting heating, stirring and filtering to remove residual metasilicate colloid in step 2;
Step 4: pouring filter residues obtained in step 3 into acid solution with the same volume as the Na₂CO₃ in step 3 for stirring, and conducting filtering after stirring;
Step 5: ultrasonically cleaning filter residues with ultrapure water, removing impurities dissolved in acid and residual acid, and obtaining high-purity quartz sand after drying.

Further, the purity of the quartz sand in step 1 is 99.74%.

Further, the heating temperature of the hydrothermal reaction in step 1 is 180-220° C., and the time of the hydrothermal reaction is 4-8 h.

Further, the concentration of the HNO₃ solution in step 2 is 4%, and the stirring rate is 200 r/min.

Further, the concentration of the Na₂CO₃ solution in step 3 is 2%, and the stirring rate is 500 r/min.

Further, the acid solution in step 4 is mixed acid of 10% HNO₃, 10% HCl and 10% H₂C₂O₄, and the stirring rate is 500 r/min.

Further, the frequency of the ultrasonic wave in step 5 is 40 kHz, and the temperature of high-temperature drying is 100-140° C.

Compared with the prior art, the present invention has the following beneficial effects: the present invention uses quartz concentrate after flotation as a raw material, destroys gas-liquid inclusions on the surface of quartz sand by a low-temperature hydrothermal method, and adopts a mixed acid leaching process to remove impurities from gas-liquid inclusions and some interlattice impurity elements in quartz sand. The technology destroys the gas-liquid inclusions by the hydrothermal method and avoids the use of HF acid in the acid leaching process, which can effectively reduce the environmental pollution caused by the acid leaching process, exhibiting excellent industrial application potential.

### DESCRIPTION OF DRAWINGS

FIG. 1 is a process flow chart of a method for removing impurities from quartz inclusions by hydrothermal denudation combined with acid leaching of the present invention.

### DETAILED DESCRIPTION

The present invention will be further described below in combination with specific embodiments, but will not be limited in any way. For the avoidance of repetition, the raw materials in the following embodiments are commercially available products unless otherwise specified, and the methods used are conventional methods unless otherwise specified.

The purity of quartz sand and the content of impurity elements thereof are determined in accordance with GB/T 32650 Determining the Content of Trace Elements in Arenaceous Quartz by Inductively Coupled Plasma Mass Spectrometry.

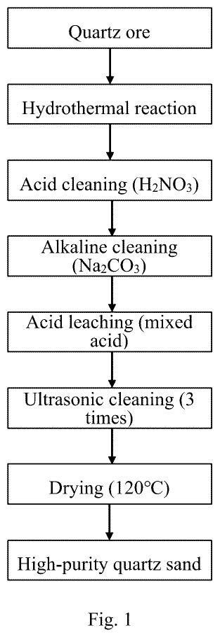

FIG. 1 shows a method for deep purification of flotation quartz concentrate. Quartz sand after flotation and CaO are subjected to hydrothermal reaction, surface silicate is removed with HNO₃ and Na₂CO₃ solution, and then the quartz sand is treated by acid leaching with mixed acid prepared from HCl, HNO₃ and H₂C₂O₄ to prepare high-purity quartz sand. The method specifically comprises the following steps:
Step 1: uniformly mixing quartz sand and CaO with a mass ratio of 10:1 with an appropriate amount of ultrapure water to prepare a slurry with a liquid-solid ratio of 5:1, pouring the slurry into a hydrothermal reactor, and placing the hydrothermal reactor in an oven for heating at a constant temperature of 180-220° C. for 4-8 h;
Step 2: removing the slurry from the hydrothermal reactor, pouring the slurry into HNO₃ solution with the same volume as the slurry in step 1, and conducting heating, stirring and filtering;
Step 3: pouring filter residues into Na₂CO₃ solution with the same volume as the HNO₃ in step 2, and conducting heating, stirring and filtering to remove residual metasilicate colloid in step 2;
Step 4: pouring filter residues into acid solution with the same volume as the HNO₃ in step 3 for stirring, and conducting filtering after stirring;
Step 5: ultrasonically cleaning filter residues with ultrapure water three times, removing impurities dissolved in acid and residual acid, and obtaining high-purity quartz sand after drying.

Contents not covered in the following embodiments shall be the same as those described in the above specific embodiments.

### Embodiment 1

Step 1: uniformly mixing 20 g of quartz sand, 2 g of CaO and 110 mL of ultrapure water to prepare a slurry with a liquid-solid ratio of 5:1, pouring the slurry into a hydrothermal reactor, and placing the hydrothermal reactor in an oven of 180° C. for heating for 6 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in embodiment 1 is shown in Table 1.

### Embodiment 2

Step 1: uniformly mixing 20 g of quartz sand, 2 g of CaO and 110 mL of ultrapure water to prepare a slurry with a liquid-solid ratio of 5:1, pouring the slurry into a hydrothermal reactor, and placing the hydrothermal reactor in an oven of 200° C. for heating for 6 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in embodiment 2 is shown in Table 1.

### Embodiment 3

Step 1: uniformly mixing 20 g of quartz sand, 2 g of CaO and 110 mL of ultrapure water to prepare a slurry with a liquid-solid ratio of 5:1, pouring the slurry into a hydrothermal reactor, and placing the hydrothermal reactor in an oven of 220° C. for heating for 6 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in embodiment 3 is shown in Table 1.

### Embodiment 4

Step 1: uniformly mixing 20 g of quartz sand, 2 g of CaO and 110 mL of ultrapure water to prepare a slurry with a liquid-solid ratio of 5:1, pouring the slurry into a hydrothermal reactor, and placing the hydrothermal reactor in an oven of 200° C. for heating for 4 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in embodiment 4 is shown in Table 1.

### Embodiment 5

Step 1: uniformly mixing 20 g of quartz sand, 2 g of CaO and 110 mL of ultrapure water to prepare a slurry with a liquid-solid ratio of 5:1, pouring the slurry into a hydrothermal reactor, and placing the hydrothermal reactor in an oven of 200° C. for heating for 8 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in embodiment 5 is shown in Table 1.

### Control Example 1

Step 1: uniformly mixing 20 g of quartz sand, 2 g of sodium hydroxide and 110 ml of ultrapure water to prepare a slurry with a liquid-solid ratio of 5:1, pouring the slurry into a hydrothermal reactor, and placing the hydrothermal reactor in an oven of 200° C. for heating for 8 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in control example 1 is shown in Table 1.

### Control Example 2

Step 1: uniformly mixing 20 g of quartz sand and 110 ml of ultrapure water to prepare a slurry with a liquid-solid ratio of 5:1, pouring the slurry into a hydrothermal reactor, and placing the hydrothermal reactor in an oven of 200° C. for heating for 8 h;
Step 2: removing the slurry from the hydrothermal reactor, pouring the slurry into HNO₃ solution with the same volume, heating to 90° C., stirring for 15 min, and conducting filtering;
Step 3: pouring filter residues obtained in step 2 into Na₂CO₃ solution with the same volume, heating to 100° C., stirring for 10 min, and conducting filtering to remove residual metasilicate colloid in step 2;
Step 4: pouring filter residues obtained in step 3 into acid solution with the same volume, stirring for 6 h, and conducting filtering after stirring;
Step 5: ultrasonically cleaning filter residues with ultrapure water three times, removing impurities dissolved in acid and residual acid, and obtaining high-purity quartz sand after drying.

The content of trace elements in quartz in control example 2 is shown in Table 1.

TABLE 1
Purity of Quartz Sand and Content of Metal Impurities in Each
Example (Unit: μg/g)

| Serial No. | Purity/% | Al | Fe | Ca | Mg | Ti |
|---|---|---|---|---|---|---|
| Example 1 | 99.978 | 28.32 | 18.2 | 21.24 | 4.64 | 11.3 |
| Example 2 | 99.986 | 14.26 | 6.89 | 6.25 | 0.68 | 11.08 |
| Example 3 | 99.992 | 12.08 | 2.7 | 2.7 | 0.12 | 10.26 |
| Example 4 | 99.962 | 26.24 | 8.84 | 8.8 | 1.42 | 11.77 |
| Example 5 | 99.996 | 11.48 | 2.78 | 2.9 | 0.24 | 6.56 |
| Control | 99.952 | 30.08 | 18.16 | 21.26 | 5.32 | 14.82 |
| example 1 | | | | | | |
| Control | 99.946 | 30.36 | 19.69 | 19.9 | 5.28 | 14.64 |
| example 2 | | | | | | |

Those skilled in the art familiar with the technical field can make various change and modifications to the technical solutions of the present invention using the technical contents disclosed above or amend same to equivalent embodiment of equivalent changes without departing from the scope of the technical solutions of the present invention. Therefore, any simple amendment, equivalent change and modification made to the above embodiments according to the technical essence of the present invention without departing from contents of technical solutions of the present invention shall fall within the protection scope of the technical solutions of the present invention.

1. A method for removing impurities in quartz inclusions by hydrothermal denudation combined with acid leaching, wherein the method comprises the following steps:
step 1: adding ultrapure water to uniformly mix quartz sand and CaO with a mass ratio of 10:1 to obtain a slurry with a liquid-solid ratio of 5:1, pouring the slurry into a hydrothermal reactor, and heating at a constant temperature;
and destroying gas-liquid inclusions on the surface of the quartz sand; wherein the time of the hydrothermal reaction is 4-8 h;
step 2: removing the slurry from the hydrothermal reactor, pouring the slurry into HNO₃ solution with the same volume as the slurry in step 1, and conducting heating, stirring and filtering;
step 3: pouring filter residues obtained in step 2 into Na₂CO₃ solution with the same volume as the HNO₃ in step 2, and conducting heating, stirring and filtering to remove residual metasilicate colloid in step 2;
step 4: pouring filter residues obtained in step 3 into acid solution with the same volume as the Na₂CO₃ in step 3 for stirring, and conducting filtering after stirring;
step 5: ultrasonically cleaning filter residues with ultrapure water, removing impurities dissolved in acid and residual acid, and obtaining high-purity quartz sand after drying.

2. The method according to claim 1, wherein the heating temperature of the hydrothermal reaction in step 1 is 180-220° C.

3. The method according to claim 1, wherein the purity of the quartz sand in step 1 is 99.74%.

4. The method according to claim 1, wherein the concentration of the HNO₃ solution in step 2 is 4%, and the stirring rate is 200 r/min.

5. The method according to claim 1, wherein the concentration of the Na₂CO₃ solution in step 3 is 2%, and the stirring rate is 500 r/min.

6. The method according to claim 1, wherein the acid solution in step 4 is mixed acid of 10% HNO₃, 10% HCl and 10% H₂C₂O₄, and the stirring rate is 500 r/min.

7. The method according to claim 1, wherein the frequency of the ultrasonic wave in step 5 is 40 kHz, and the temperature of high-temperature drying is 120° C.
